(19) United States
(12) Patent Application Publication
(10) Pub. No.: US 2015/0071627 A1
(43) Pub. Date: Mar. 12, 2015

(54) Automated Stabilizing Apparatus

(71) Applicant: Chi Khai Hoang, Newbury Park, CA (US)

(72) Inventor: Chi Khai Hoang, Newbury Park, CA (US)

(73) Assignee: Chi Khai Hoang, Newbury Park, CA (US)

(21) Appl. No.: 14/484,823

(22) Filed: Sep. 12, 2014

Related U.S. Application Data
(60) Provisional application No. 61/877,163, filed on Sep. 12, 2013.

(51) Int. Cl. G03B 17/56

(52) U.S. Cl. CPC G03B 17/561
USPC 396/421

(57) ABSTRACT

An automated stabilizing apparatus includes a bracket to mount an image device such as a camcorder or camera phone and a differential gear assembly connected to the bracket; a first and second drive system, consists of a bidirectional DC motor, an encoder, and a gear train, having an output shaft couples to the differential gear assembly; and an electronic enclosure houses controls elements that include a microcontroller, motor drivers, and sensors in communication with the drive systems to maintain the bracket and image device steady over a wide range of positions.

### BACKGROUND OF THE INVENTION

When shooting videos using an imaging device such as a camera phone or a light camcorder, hand and body movements tend to transmit to the camera thus producing shaky videos. There are imaging devices with features such as built-in image stabilization to improve the video quality, and these features utilize either a software image stabilization technique to smooth minor jitters in the video or an optical stabilization technique where a lens is physically shifted inside the camera to counter the movements of the camera body. In general, these techniques work well for small vibrations measured within a few degrees of movement, however, larger rotating movements of the camera associated with walking or running requires other external devices to stabilize the camera.

For many years, a device such as a steadycam uses a counterweight to balance the camera such that the camera and the counterweigh pivot about a swivel joint located somewhere in between. As the operator's hand rocks back and forth during operation, the camera remains leveled due to the counterweight and the resulting video image is generally steady.

There are a few disadvantages to this design. The camera has to be balanced with the counterweight to remain leveled and once it is in a balanced position, it cannot be pitched up or down and still remain stabilized. The device is bulky and general difficult to operate due to the inherent lack of controls in pitching or panning motion.

In the past few years, motorized camera stabilizer commonly called brushless gimbals have been introduced that solve many of the problems associated with the mechanical, counterweight stabilizers. Generally, brushless gimbals utilize motors to drive the camera about the pitch, roll, and yaw axis and allow the user to pitch the camera up and down smoothly by pressing a corresponding button.

While brushless gimbals are relatively easy to use when paired with a predefined camera, however the low torque, brushless motors require calibration when used with cameras of slightly difference in weight. Also, a unique mounting bracket is needed for cameras of different geometries such that the center of gravity of the camera has to be in line with the center axis of motor rotation at all times. This makes the brushless gimbal not conveniently adaptable to different camera types, and therefore most manufacturers simply make a unique brushless gimbal for one or two of the most popular camera models. Lastly, the configuration of the brushless motors relative to the camera prevents the operator to view the camera screen during operation.

### SUMMARY OF THE INVENTION

It is the object of the present invention to provide an automatic stabilizer apparatus using a differential gear configuration that is compact, lightweight, attractive, simple to use, inexpensive to manufacture, and versatile in adapting to multiple types of imaging devices.

The apparatus includes: a first and second drive assembly that are positioned opposite and collinear to each other and attached to the electrical compartment, a differential gear assembly containing three miter gears housed in a configuration such that two opposing drive gears mesh with the third gear being the driven gear, and each drive gear is attached to the output shaft of the drive assembly, a camera bracket, having a thumb screw to secure an imaging device, attached to one end of the driven gear such that the driven gear and the camera bracket rotates in unison, an electronic housing having orientation sensors, main processor unit, power management and drive circuit, and a removable handle, attached to the underside of the electronic housing, having batteries to power the device.

When both drive gears rotate in the opposite direction, and at the same speed, the camera pitches about the axis along the centerline of the drive gears, and when the drive gears rotate in the same direction, and at the same speed, the camera rolls about the axis along the centerline of the driven gear. Varied speed and direction of the two drive motors enable the camera to rotate in any combinations of motions about the two axes.

In my present application I have developed and applied the benefit of the differential drive system to an automatic stabilizer apparatus to provide stabilization of the camera in the pitch and roll axis while maintaining a small footprint and allowing the operator to have full view of the camera display screen.

### BRIEF DESCRIPTION OF THE DRAWINGS:

These, as well as other features of the present invention, will become more apparent upon reference to the drawings wherein:

FIG. 1 is a perspective view of the automatic stabilization apparatus with a handle attached to the bottom surface of the body structure, illustrating the apparatus in the handheld operation;

FIG. 2 is an exploded view of the automatic stabilization apparatus breaking up into major assemblies;

FIG. 3 is a perspective and exploded view of the first and second drive assembly;

FIG. 4 is a perspective view of the rotary optical encoder;

FIG. 5 is a perspective and exploded view of the rotary magnetic encoder;

FIG. 6 is a perspective and exploded view of the rotary potentiometer;

FIG. 7 is an exploded view of the differential gear assembly;

FIG. 8 is an exploded view of the main support structure with electronic boards;

FIG. 9c is a perspective view of a portable battery pack;

FIG. 9b is a perspective view of a 12V vehicle power adapter;

FIG. 9c is a perspective view of a removable handle with battery cells;

FIG. 10a is a perspective view of the automated stabilizer apparatus with reference coordinate frames;

FIG. 10b is a side view of the automated stabilizer apparatus with reference coordinate frames;

FIG. 10c is a front view of the automated stabilizer apparatus with reference coordinate frames.

### DETAILED DESCRIPTION OF THE INVENTION

While the invention is described in conjunction with the accompanying drawings, the drawings are for purposes of illustrating exemplary embodiments of the invention and are not to be construed as limiting the invention to such embodiments. It is understood that the invention may take form in various components and arrangement of components beyond those provided in the drawings and associated description. Within the drawings, like reference numerals denote like elements. The term “device” is frequently used in describing an imaging object mounted to the apparatus which means a camera, video recorder, camera phone, laser, lens, and sensors.

The automatic stabilization apparatus is comprised of several subassemblies, which combined to provide device control while giving special consideration to the physical size, visual obtrusiveness, adaptability to different devices, and cost of manufacturability. In other words, an automatic stabilization apparatus is small, light, attractive, and inexpensive.

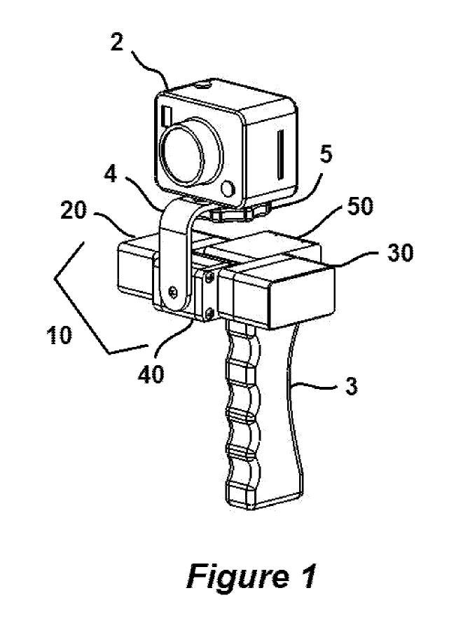

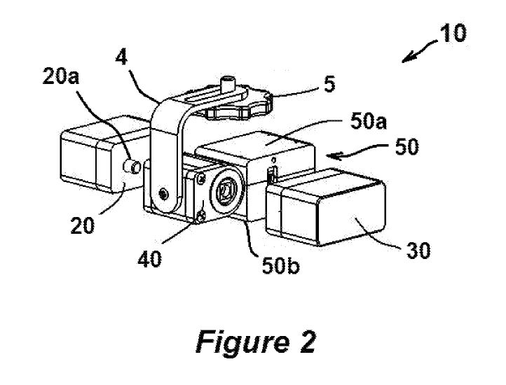

FIGS. 1 and 2 depicts the preferred embodiment of the apparatus 10 incorporating aspects of the invention in the perspective view. The apparatus 10 includes a first 20 and a second 30 drive system each having an output shaft 20a attaching to two sides of the differential gear assembly 40. A device mounting bracket 4 attaches to the differential gear assembly 40 on one end while securing a device such as a camera 2 on top utilizing a thumb screw 5. The controls electronics are housed inside the main support 50 having a top 50a and a bottom 50b shell that are rigidly held together; the main support 50 has attachment screw holes on the sides to support first 20 and second 30 drive system and a threaded screw hole on the bottom surface for mounting the apparatus to external structure or to a handle 3 in handheld applications.

### Drive System

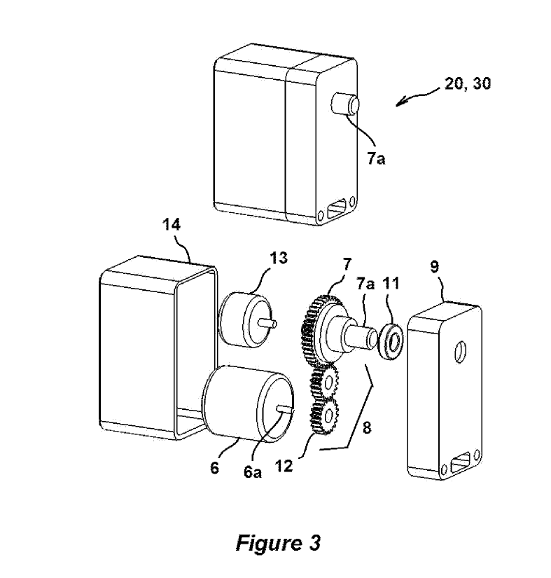

FIG. 3 illustrates the inner components of the drive systems 20 & 30 having a motor 6 transmitting torque through a gear train 8 to an output shaft 7a of the final gear 7 of the assembly. The output shaft 7a, supported by at least one ball bearing 11, extends beyond the drive housing 9 to couple to the differential gear. The gear train 8 contains a series of spur gears 12 with varied pitch diameters to produce mechanical leverage through gear reduction. A high gear reduction is achieved when the motor shaft 6a rotates many rotations for every rotation of the output shaft 7a. Gear reduction allows a motor to rotate a load that requires much larger torque than the motor can produce on its own.

It is worth to mention that although FIG. 3 illustrates three spur gears arranged in series to transfer torque to the output shaft 7a, the present invention is not limited by the quantity or configuration of gears. A gear train of any configuration and components that achieve a gear reduction as previously described can be used in the system of the present invention. Similarly, the motor 6 in the preferred embodiment is a high speed DC motor having an output shaft 6a attached to a spur gear in the train 8. In some other embodiment the motor can be a stepper motor, brushless motor, or geared motors.

Referring to FIGS. 1 to 3, both output shafts 7a transmit torque from the motor 6 to the differential gear assembly 40 as well as support the weight of the differential gear assembly 40 and the device; Ball bearings 11 located on both sides of the final gear 7 provide rigidity to the output shaft 7a while minimizes rotation friction. Coupled to one end of the final gear 7 is a rotary encoder 13 that record and transmit angular position used as feedback signal to the main processor. By coupling the rotary encoder 13 to the output shaft 7b, the feedback position reading is more accurate without being affected by gear backlash as compared to coupling the encoder directly to the motor shaft.

The enclosure 14, is injection molded or machined, having means to mates to the drive housing 9 to add rigidity to the drive system and to prevent dirt from contaminating the spur gears. The drive housing 9 is a central structural component of the drive system because it provides rigidity for the drive train and contains location holes for gear shafts and ball bearings 11. It is this component that allows the spur gears to rotate smoothly without rub or play during operation. In the preferred embodiment, the housing 9 is made from high strength engineer plastic through injection molding using manufacturing technics required to hold very tight tolerances. In some other embodiment, the housing 9 is fabricated from metal such as aluminum where tight tolerances can be easily achieved.

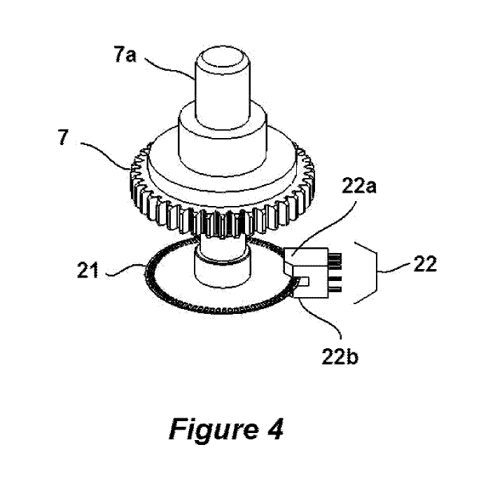

Referring to FIG. 4, where in one embodiment, the rotary encoder coupled to the output shaft 7a is an optical incremental encoder utilizing a light sensor 22 and a slotted wheel 21 to detect changes in movement in the output shaft 7a. This type of encoder is well known and frequently used in industrial applications where the encoder is commonly mounted to the shaft of the drive motor. The slotted wheel 21 is rigidly attached to the output shaft 7a; thus, when the output shaft 7a rotates, the slits near the edge of the wheel 21 move over the LED 22a and light sensor 22b creating interruptions to the light path between the LED 22a and the light sensor 22b. This interruption is transmitted as a signal to the main processor to indicate changes in rotary position.

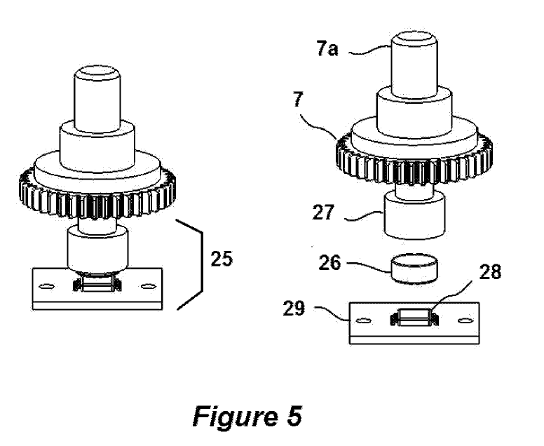

In some other embodiment feedback signal, illustrated in FIG. 5, is provided by a magnetic encoder 25 consist of two main components. The first component is the disc 26 which is magnetized with north and south poles divided diametrically along the centerline of the circular surface. The second component is the chip based hall effect sensor 28 soldered to a circuit board 29 having mounting holes for attachment to drive housing. The magnetic disc 26 is securely housed in a tube 27 attached to the output shaft 7a, therefore all three components turn in unison. There is an air gap between the sensor 28 and the magnetic disc 26; as the disc 26 turns and hovers over the sensor 28, change in output signal is generated due to the change in magnetic field. A controller built inside the chip 28 converts this signal into meaningful rotary positions to feed to the main processor. One example of this particular type of sensor is the AS5048 by Austria Micro Systems.

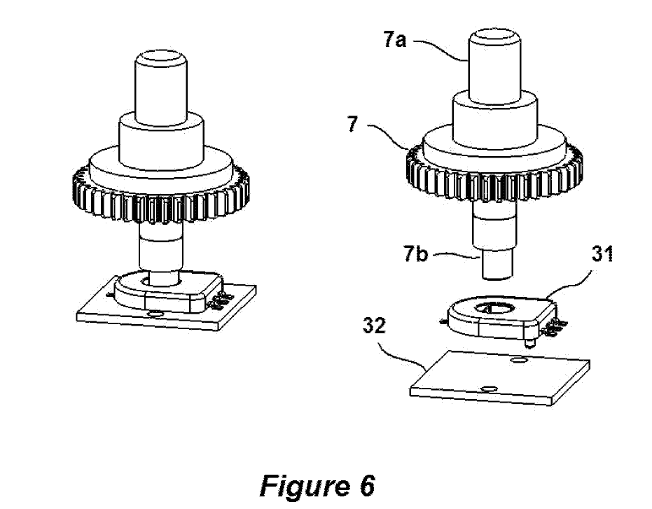

In yet another embodiment, illustrated in FIG. 6, feedback signal is provided by a rotary potentiometer 31 used to sense absolute position of the output shaft 7a. Potentiometers are generally not as accurate as the two encoders mentioned above, but they are very inexpensive due to availability and simplicity in construction. The major components of the rotary potentiometer 31 include a wiper, resistive arc, and housing with terminals soldered to a circuit board 32 having mounting holes for attachment to drive housing. The wiper attached to the shaft adaptor 7b such that as the output shaft 7a rotates, the wiper sweeps over the resistive arc producing change in electrical resistivity at the output terminals between the wiper and resistive arc. When a constant voltage is applied across the resistive arc, change in electrical resistivity results in a corresponding change in voltage at the output terminals between the wiper and any terminal of the arc. This signal is sensed by the main processor to compute as absolute rotary position of the output shaft 7a.

### Differential Gear Assembly

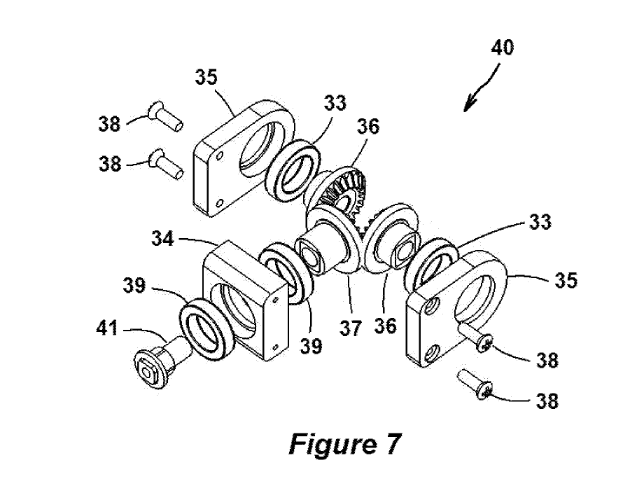

FIG. 7 depicts the differential gear assembly 40 of the apparatus where the three miter gears 36 & 37 are situated inside a bearing housing. The bearing housing consists of a body 34 and one leaf 35 attached to each side of the body 34. Each leave 35 is rigidly attached to the body 34 using two fastening screws 38 and houses at least one ball bearing 33 that slides over the shaft of the drive gear 36. The ball bearings 33 enable the differential gear assembly 40 to tilt about the center axis of the drive gears 36 with minimal friction. The body 34 contains two ball bearings 39 that slide over the shaft of the driven gear 37. These ball bearings 39 enable the gear adaptor 41 to roll about the center axis of the driven gear 37 with minimal friction. The bearing housing aligns the gears 36 & 37 at a predetermined distance that enables the drive gears 36 and a driven gear 37 to mesh with minimal rub and backlash. This is an important factor since backlash has a direct effect on ability to precisely position the device during operation; a minute backlash in the differential gear is amplified by the distance of the device to the gear. In some other embodiments, crown gears, spiral gears, or spur gears are used in place of miter gears.

In FIGS. 1 & 7, the angle bracket 4 is attached to a gear adaptor 41 that is rigidly coupled to the output shaft of the differential gear drive 40. A cam feature on the mating surfaces of the adaptor 41 and the bracket 4 enable the two members to rotate in unison with no backlash during operation. The device is mounted on top of the angle bracket using a thumb screw 5 having a mating threaded end, usually thread size ¼-20. Different angle brackets are used depending on the shape of various devices mounted on the apparatus

This invention does not restrict the device to be positioned on top of the apparatus. In some other embodiments, the device is positioned in front of the apparatus or below the apparatus by using different device mounting brackets.

### Main Structure and Electronic Enclosure

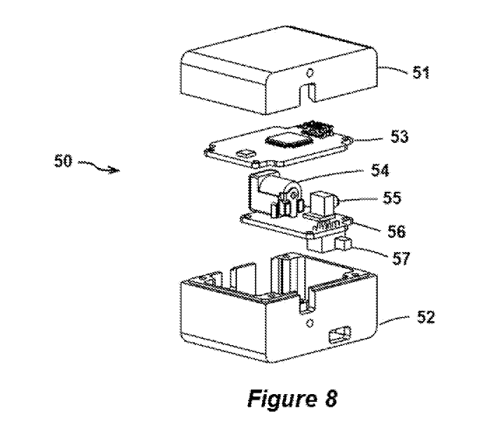

FIG. 8 illustrates the preferred embodiment of the main structure 50 of the apparatus having a top 51 and bottom 52 shell enclosing electronic components contained within. Four threaded holes allow the drive systems to rigidly mount to both sides of the structure 50; a threaded screw hole, size ¼-20, located on the bottom surface of the structure 50 enables the apparatus to be attached to a moving vehicle or to a handle for handheld applications. The main structure 50 directly supports the entire weight of the apparatus and the device, therefore mechanical strength is the primary consideration in its design without sacrificing the overall footprint and weight.

In some other embodiment, the bottom shell 52 of the main structure 50 and the motor housings 9 (FIG. 3) are fabricated as one piece. This design further strengthens the overall structure of the apparatus as well as reduces the number of components in assembly.

There are two circuit boards 53 & 56 housed inside the main structure; sensors and control components are located on the first board 53, and power distribution components are located on the second board 56. An opening on each side of the structure 50 enables power and signal wires to be routed from the circuit boards 53 & 56 to the motors and rotary encoders in the drive systems.

A microcontroller, resides on the first circuit board 53, performs continuous system control loops including updating sensor signals to determine the current physical orientation of the apparatus, processing controls algorithm to determine a trajectory path for the motors, and finally send commands to drive the motors. Also located on the first circuit board 53 are chip based sensors capable of measuring orientation of the apparatus at a very high rate of speed such that fresh orientation data are communicated to the microcontroller upon request. Finally, sharing the same circuit board 53 are the motor driver chips that convert signals from the microcontroller into speed and direction commands to the drive motors.

An ON-OFF switch 57, control button 55, and power socket 54 located around the sides of the apparatus provide means for the operator to interface with the apparatus. A socket, terminal strip or connector may be positioned such that the socket 54 is exposed for quick and error-proof connection of the power adaptor. The socket 54 is preferably attached firmly to the second circuit board 56 by soldering to eliminate the needs for power wires from the socket 54 to the circuit board 56. Control buttons 55, may be multi-position slide switch, momentary contact switch, or permanent contact switch, are used to select different modes of operation preprogrammed into the microcontroller.

It is worth to mention that although FIG. 8 illustrates a control button and slide switch located around the sides of the main structure, the present invention is not limited by the quantity, type, or location of the input components or the number of circuit board or the location of electrical components. A mechanical button and slide switch may be replaced by a pressure switch, capacitive switch, or thermo switch. Two circuit boards may be replaced by one where all electronic components populate on top and bottom side of the board.

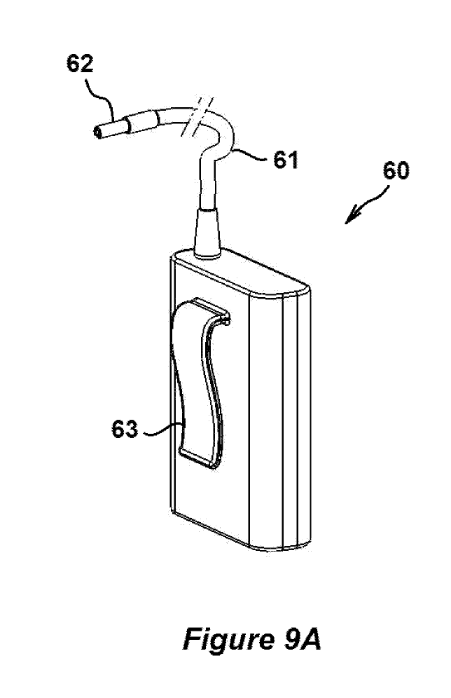

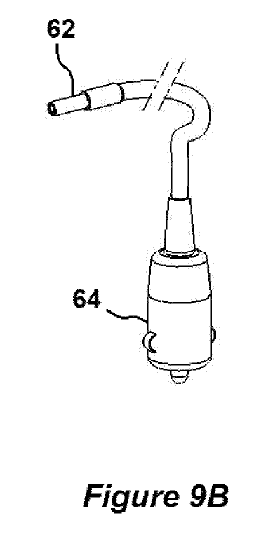

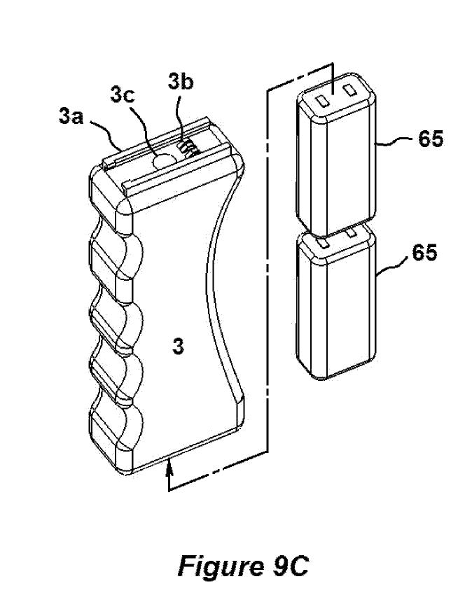

As shown in FIG. 9a, in the preferred embodiment, power is provided to the apparatus through a portable rechargeable battery pack 60, having a cable 61 connected to a power adaptor 62. The portable battery pack 60 contains a plurality of Lithium-ion cells such that sufficient power is provided to operate the apparatus for at least 15 minutes during normal operation. Built into the housing of the battery pack is a clip 63 or strap for attachment to an article of clothing.

Turning to FIG. 9b, power can also be provided to the apparatus through a voltage adaptor 64 connected to the industry standard cigarette lighter inside a vehicle. Power generated by the vehicle allows for lengthy operation of the apparatus as long as the vehicle engine is running and the vehicle battery is sufficiently charged.

Referring to FIGS. 1 & 9c, in another embodiment, battery cells 65 providing power to the apparatus are housed inside the handle 3 which attaches to the bottom face of the main structure 50. The mating surface of the handle 3 contains two rails 3a, a screw hole 3c, and spring-loaded terminals 3b. The rails 3a and the screw hole 3c are designed to firmly latch the handle 3 to the main structure 50 such that the terminals 3b, which transmit power from the battery cell 65, make sufficient contact with electrical pads on the bottom face of the main structure 50.

Main Electronic Components and their Functions

The microcontroller is a main processor that coordinates and controls all major activities in the system. The sequence of operation, written in program codes and resides in the memory within the microcontroller, is performed in a perpetual programming loop at a high rate of speed.

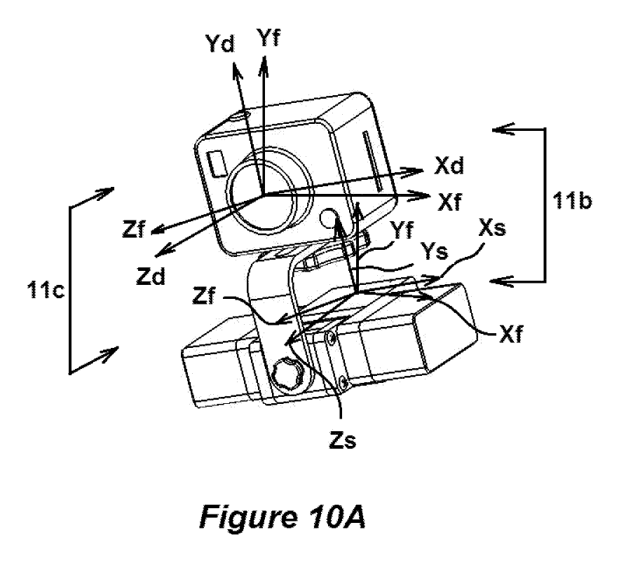

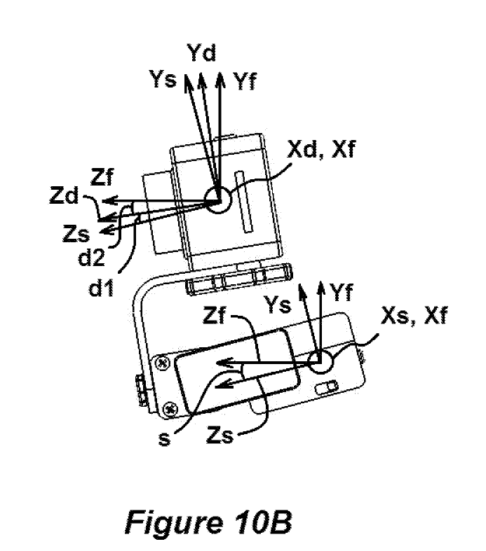

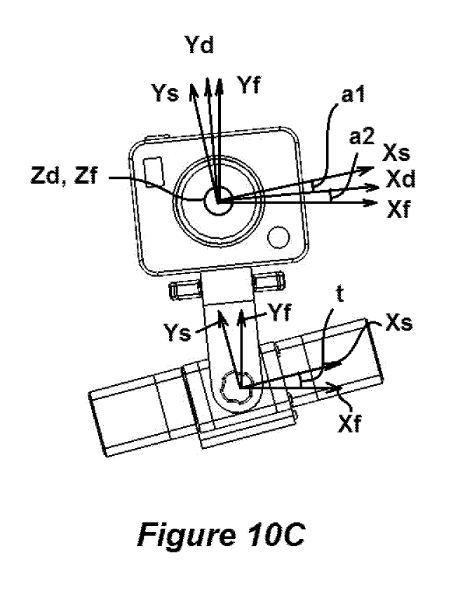

When magnetic encoders are used for feedback, the magnetic encoder chips communicate the current angle positions of the drive shafts to the microcontroller. These values are then converted to orientation angles of the device relative to a fixed frame by the microcontroller. FIG. 10a illustrates the three frames denoted by X, Y, and Z coordinates where:
Xd, Yd, Zd represent rotation coordinates of the device
Xs, Ys, Zs represent rotation coordinates of the sensor
Xf, Yf, Zf represent fixed coordinates used as reference

In applications where the device coordinates (Xd, Yd, Zd) need to be stabilized with respect to the fixed coordinates (Xf, Yf, Zf), the sensor measures its absolute orientation (Xs, Ys, Zs) relative to the fixed coordinates and feeds this data to the microcontroller. The device coordinates are usually not equal to fixed coordinates while the apparatus is in motion; this is because the sensor measures current rotation of the apparatus and the device is at the position based on previous loop command. Adjustments are always made by the microcontroller to minimize the error between the device coordinate and the fixed coordinate.

FIG. 10b illustrates an instant when the device needs to tilt (rotate about the Xd axis) to maintain leveled with respect to the fixed axis. While the sensor reads the absolute tilt angle s of the apparatus, the encoders provides the tilt angle d1 of the device relative to the sensor. The motors have to rotate the device an angle equivalent to d2, which is s minus d1. In the differential drive configuration, the microcontroller commands the motors to rotate in the opposite directions and at the same speed to achieve tilting motion.

FIG. 10c shows an example where the device needs to roll about the Zd axis to maintain leveled. The sensor reads the angle t, which is Xs relative to Xf, and the encoder provides roll angle a2, which is Xd relative to Xs. Thus, the motors must rotate the device an angle equivalent to a1 (t minus a2). The microcontroller commands the motors to rotate in the same direction and at the same speed to roll about the Zd axis. Varied speed and direction of the two drive motors enable the driven gear the device to rotate in any combinations of motions about the two axes.

In every process loop, the microcontroller communicates with the sensors through a high speed serial bus such as serial peripheral interface (SPI) to acquire current orientation data of the sensors relative to a fixed frame. In the preferred embodiment, the sensor is a microelectralmechanical (MEMS) inertial measurement unit (IMU) having a rate gyro, accelerometer, magnetometer (or compass), and a central processing engine built into one chip. Due to recent advanced in MEMS manufacturing techniques, this type of sensor has only been available for mass distribution in recent years. Sensors such as a MPU-6000 produced by Invensense and BMX055 by Bosch Sensortec enables a single chip to accommodate a footprint of approximately 4×4 mm on the circuit board whereas three components were needed in the past.

Another major advantage of having three sensors built into one chip is that the misalignments between sensors axes are dramatically reduced. For example, when individual chips such as rate gyro and an accelerometer are soldered separately on a circuit board, tolerances inherent in the handling process will cause the axes to not be parallel. Therefore, every board is unique and complicated calibration procedure is required to accommodate for axes misalignment. For the single chip sensor, misalignment is at a micron scale in the MEMS manufacturing processes and is negligible in most applications.

Furthermore, the benefit of having a processing engine on board the chip to perform complicated algorithms is to free up the microcontroller to complete other tasks. Typically, the accelerometer and rate gyro send out raw data, or unfiltered data, to the microcontroller for processing. Signals from the accelerometer are inherently unstable due to external vibration or electrical noise; likewise the measurements from the rate gyro are not entirely useful due to accumulating drift over time, which is typical of any MEMS rate gyro. Companies such as Invensense and Bosch Sensortec have developed their own algorithms to combine the features of both sensors while discriminate noise and unwanted vibration to produce smooth and accurate output signals. With the processor engine built in the sensor chip, the time consuming algorithm calculations are performed entirely inside the sensor chip and not the microcontroller. The result is an inexpensive and reliable sensor that measures absolute orientation of the base of the apparatus relative to a fixed frame.

Finally, the motor drivers are the last major control components on the circuit board. In this embodiment, the drive source consists of two bidirectional DC motors. In some other embodiments, stepper motors, brushless motors, or gear motors are used such that sufficient torque is generated by the motors to move the device expeditiously. For bidirectional DC motors, the driver typically consists of an H-bridge electronic circuit built into a chip that enables a voltage be applied across a motor in either direction. Pulsing this voltage effectively permits the motor to run at different speeds in either direction. The driver communicates with the microcontroller through a plurality of digital pins such that a low voltage pulse train from the microcontroller is received by the driver which then produces higher voltage required to drive the motors. Longer pulses or duty cycle correspond to higher output torque and faster motor speed.

In every processing loop, the microcontroller retrieves the latest signals from the two encoders to establish the most current position of the drive shafts. The drive motors are then commanded to rotate at speeds according to how far the device is from a desired position as calculated by the microcontroller. The farther the device is from a desired position, the faster the motors must move to compensate for the difference. A proportional-Integral-Differential (PID) control system is implemented by the microcontroller to control the motor most expediently as well as produce minimal system instability.

The invention claimed is:

1. An automatic stabilizer apparatus comprising:
a differential gear assembly wherein two drive gears transmit rotational movement to one driven gear to produce rotation of the driven gear about the first axis along the centerline of the driven gear and the second axis along the centerline of the drive gears;
a pair of motor assemblies with output shafts having means for transmitting torque to the drive gears of the differential gear assembly;
a camera bracket having means for attaching to one end of the driven gear such that bracket and driven gear rotate in unison; and
an electronic housing containing a central processing unit, orientation sensors, power management and drive circuit to energize the motors.

2. The two drive gears in the differential gear assembly in claim 1 are positioned collinearly and mirror each other with gear teeth point toward each other.

3. The driven gear in the differential gear assembly in claim 1 is positioned 90 degrees to the drive gears.

4. The drive gears and driven gear in the differential gear assembly in claim 1 are made from plastic or metal in their entirety or in part.

5. The drive gears and driven gear in the differential gear assembly in claim 1 are miter gears, bevel gears, or crown gears.

6. The motor assemblies in claim 1 contain servo motors, gear motors, brushed motors, brushless motors, stepper motors, or hobby RC servos.

7. The motor assemblies in claim 1 contain optical rotary encoders, magnetic encoders, or potentiometers attached to the output shafts to record rotational position of the output shafts.

8. The camera bracket in claim 1 permits the camera to situate above the stabilizing head, in front of the stabilizing head, or underneath the stabilizing head.

9. The camera bracket in claim 1 contains a thumb screw to secure the camera.

11. The electronic housing in claim 1 contains orientation sensors including a MEMS accelerometer and rate gyroscope.

12. The electronic housing in claim 1 contains ON/OFF switch, controls switches, and power jack for operation using external battery pack.

13. The automatic stabilizer apparatus in claim 1 is powered by an external battery pack containing sufficient power to operate the device for at least 15 minutes.

14. The automatic stabilizer apparatus in claim 1 is powered by a car charger producing 12 VDC.

15. The automatic stabilizer apparatus in claim 1 is powered by battery cells located inside the removable handle having means to transmit power through mating connectors.
